(19) United States
(12) Patent Application Publication
(10) Pub. No.: US 2004/0252093 A1
(43) Pub. Date: Dec. 16, 2004

(54) Liquid crystal display apparatus

(76) Inventor: Jin-Ho Park, Suwon-si (KR)

Correspondence Address: CANTOR COLBURN LLP, 55 Griffin Road South, Bloomfield, CT, 06002, US

(21) Appl. No.: 10/756,939

(22) Filed: Jan. 14, 2004

(30) Foreign Application Priority Data
Jun. 10, 2003 (KR) 2003-36992

(51) Int. Cl. G09G 3/36

(52) U.S. Cl. 345/94

(57) ABSTRACT

In an LCD apparatus, an LCD panel receives an image data from a data driver and displays an image in response to a gate driving signal from a gate driver. A timing controller provides a first control signal to the gate driver so as to control an output of the gate driving signal and provides a second control signal to the data driver via a signal line formed on the LCD panel so as to control an output of the image data. Accordingly, the gate driving signal and image data may be applied to a corresponding pixel area at the same time. Also, the LCD apparatus may prevent deterioration of the image, which is caused by applying-time difference between the gate driving signal and image data, thereby improving the display quality thereof.

### CROSS-REFERENCE TO RELATED APPLICATION

This application relies for priority upon Korean Patent Application No. 2003-36992 filed on Jun. 10, 2003, the contents of which are herein incorporated by reference in its entirety.

### BACKGROUND OF THE INVENTION

1. Field of the Invention

The present invention relates to an LCD (Liquid Crystal Display) apparatus, and more particularly to an LCD apparatus having a high display quality.

2. Description of the Related Art

In recent, a semiconductor device having a high integration and a high effectiveness has been developed according to an advanced technology of a semiconductor thin film process. The semiconductor thin film process has affected a development of a FPD (Flat Panel Display) apparatuses. An LCD (Liquid Crystal Display) apparatus having various characteristics, for example, such as a small size, low power consumption, a high resolution, etc., is widely applied to electronic instruments, for example, such as a notebook computer, a monitor, a mobile communication system and so on.

The LCD apparatus, generally, includes an LCD panel for displaying an image and a PCB (Printed Circuit Board) that generates a driving signal for driving the LCD panel. The LCD panel includes a TFT (Thin Film Transistor) substrate, a color filter substrate facing the TFT substrate and a liquid crystal layer interposed between the TFT substrate and color filter substrate.

FIG. 1 is a schematic view showing a conventional LCD apparatus.

Referring to FIG. 1, a conventional LCD apparatus 600 includes a TFT substrate 100 having a plurality of gate lines GL and a plurality of data lines DL substantially perpendicular to the gate lines GL, a gate PCB 110 for applying a gate driving signal to the gate lines GL, and a data PCB 120 for applying a data signal to the data lines DL. A pixel is formed at a position where the data and gate lines are intersected with each other.

Although not shown in FIG. 1, the conventional LCD apparatus 600 further includes a color filter substrate facing the TFT substrate 100 and having a color filter and a common electrode.

The gate and data PCBs 110 and 120 are electrically connected with the gate and data lines GL and DL via a gate TCP (Tape Carrier Package) 130 and a data TCP 140, respectively. The gate TCP 130 includes a gate driving chip 150 formed thereon and the data TCP 140 includes a data driving chip 160 formed thereon.

That is, the data driving chip 160 stores the data signal inputted from the data PCB 120 by a bit until the data signal corresponding to one horizontal line of a display screen is stored in the driving chip 160. Then, the data driving chip 160 converts the stored data signal into an analog data signal in response to the output instruction signal TP and outputs the converted analog data signal to the data lines DL.

The output instruction signal TP is generated from a timing controller 170 disposed on the data PCB 120 and the generated output instruction signal TP is provided to the data driving chip 160 via an output instruction signal line 180. The output instruction signal line 180 is disposed on the data PCB 120 and electrically connected to the data driving chip 160 by means of the data TCP 140. Thus, the output instruction signal TP is provided to the data driving chip 160 via the output instruction signal line 180 and data TCP 140.

When the gate driving signal from the gate driving chip 150 is provided to a TFT (not shown) via a corresponding gate line GL, the TFT is turned on so as to allow an analog voltage inputted via a corresponding data line DL to be supplied to a corresponding pixel.

The gate lines GL are disposed on the TFT substrate 100 and have a capacitive load because the gate lines GL act as a capacitor with the common electrode formed on the color filter substrate. Also, since the gate lines GL comprise a metal material, the gate lines GL have a resistive load.

Accordingly, in order to apply the gate driving signal to a specific TFT (not shown) positioned at a place, where a spaced-apart distance from the gate driving chip 150 is greater than that of another TFT (not shown) adjacent to the gate driving chip 150, the time for applying the gate driving signal to the specific TFT may be delayed than the time for applying the gate driving signal to the TFT adjacent to the gate driving chip 150 because the gate driving signal is applied to the TFTs via the gate lines GL having the capacitive load and resistive load of the gate lines GL.

FIG. 2 is waveforms showing delay characteristics of the data and gate signals according to length of the gate and data lines shown in FIG. 1.

Referring to FIG. 2, when the gate driving signal from the gate driving chip 150 is provided to the corresponding gate line GL, the gate driving signal applied to a second area “b” and a third area “c” is delayed in a predetermined time in comparison with the gate driving signal applied to a first area “a”.

That is, a gate driving signal g2 applied to the second area “b” of the gate lines GL is delayed by a first time t1 compared with a gate driving signal g1 applied to the first area “a” of the gate lines GL.

Also, a gate driving signal g3 applied to the third area “c” of the gate lines GL is delayed by a second time t2 compared with the gate driving signal g1 applied to the first area “a” of the gate lines GL. The reason that the gate driving signal g3 applied to the third area “c” is more delayed than the gate driving signal g2 applied to the second area “b” is because the third area “c” is more apart from the gate driving chip 150 than the second area “b”. That is, the capacitive load and resistive load are gradually increased according to the length of the gate lines GL.

A data signal “d” outputted from the data driving chip 160 to the data lines DL by the output instruction signal TP always has same waveforms regardless the first to third areas “a”, “b” and “c”, where the data lines are located.

That is, the data signal provided by the data driving chip 160 in the first area “a”, the data signal in the second area “b” and the data signal in the third area “c” have same waveforms.

As shown in FIG. 1, the output instruction signal line 180 that provides the output instruction signal TP to the data driving chip 160 is formed on the data PCB 120, so that the output instruction signal line 180 does not have the capacitive load as that of the gate lines GL.

Accordingly, the data signal “d” provided from the data driving chip 160 to the data lines DL by the output instruction signal TP may be provided to the TFTs (not shown) at the same time without positions of the first, second and third areas “a, b and c” as shown in FIG. 2.

Therefore, in the conventional LCD apparatus, a waveform of the data signal is not equal to a waveform of the gate driving signal. As a result, the gate driving signal may not be applied to the gate lines GL while the data signal is applied to the corresponding data lines DL, thereby an abnormal image displayed on the display screen of the LCD apparatus.

### BRIEF SUMMARY OF THE INVENTION

The present invention provides an LCD apparatus having a high display quality.

In one aspect of the invention, an LCD apparatus includes an LCD panel receiving an image data externally provided and displaying an image, a data driver outputting the image data to the LCD panel, a gate driver outputting a gate driving signal to the LCD panel, and a timing controller controlling the gate driving signal and image data.

The timing controller provides a first control signal to the gate driver so as to control an output of the gate driving signal and provides a second control signal to the data driver via a signal line formed on the LCD panel so as to control an output of the image data.

In another aspect of the invention, an LCD apparatus includes an LCD panel receiving an image data and displaying an image, a data driver outputting the image data to the LCD panel, a gate driver outputting a gate driving signal to the LCD panel, a timing controller controlling the gate driving signal and image data, a plurality of signal transmission members electrically connecting the data driver with the LCD panel, and a signal line providing the second control signal to the data driver via one of the signal transmission members.

The timing controller provides a first control signal to the gate driver so as to control an output timing of the gate driving signal and provides a second control signal to the data driver so as to control an output timing of the image data.

According to the LCD apparatus, the gate driving signal and image data may be applied to a corresponding pixel area at the same time. Thus, the LCD apparatus may prevent deterioration of the image, which is caused by applying-time difference between the gate driving signal and image data, thereby improving the display quality thereof.

### BRIEF DESCRIPTION OF THE DRAWINGS

The above and other advantages of the present invention will become readily apparent by reference to the following detailed description when considered in conjunction with the accompanying drawings wherein:

FIG. 1 is a schematic view showing a conventional LCD apparatus;

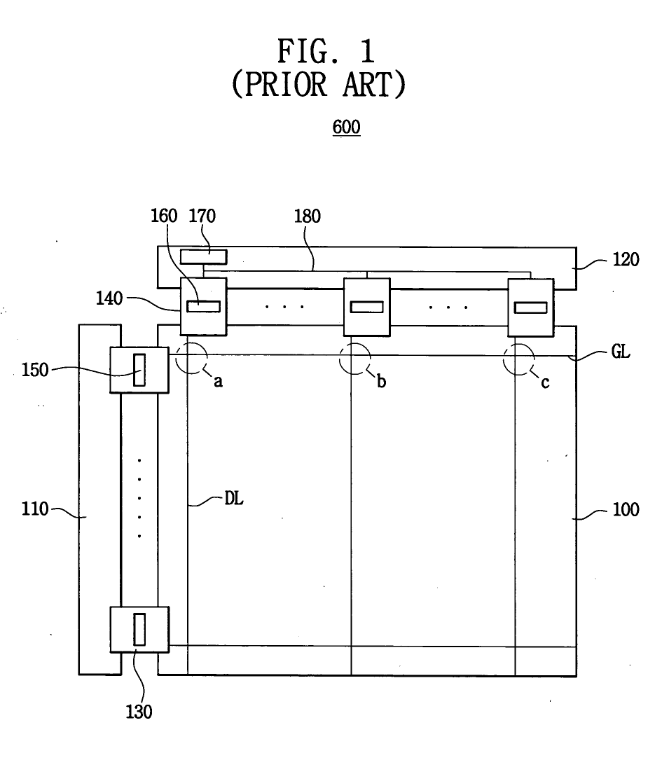

FIG. 2 is waveforms showing delay characteristics of the data and gate signals according to length of the gate and data lines shown in FIG. 1;

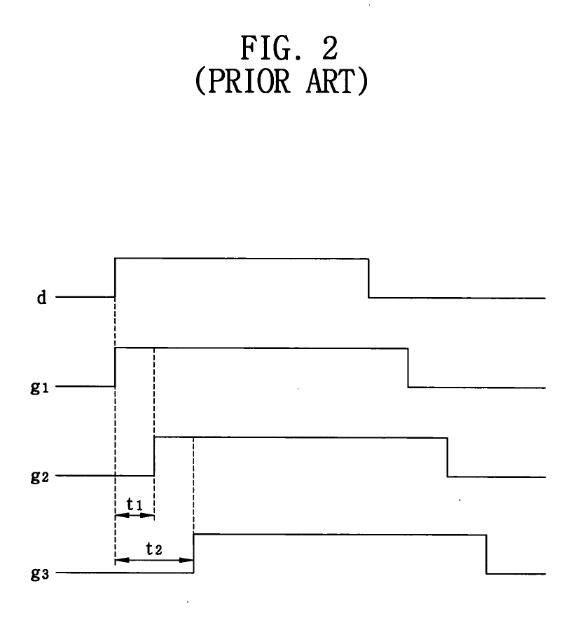

FIG. 3 is an exploded perspective view showing an LCD apparatus according to an exemplary embodiment of the present invention;

FIG. 4 is a schematic plane view showing a TFT substrate and a PCB substrate shown in FIG. 3;

FIG. 5 is a block diagram showing the data driving chip shown in FIG. 3; and

FIG. 6 is waveforms of the data and gate signals applied to areas “A” to “C” shown in FIG. 4.

### DETAILED DESCRIPTION OF THE INVENTION

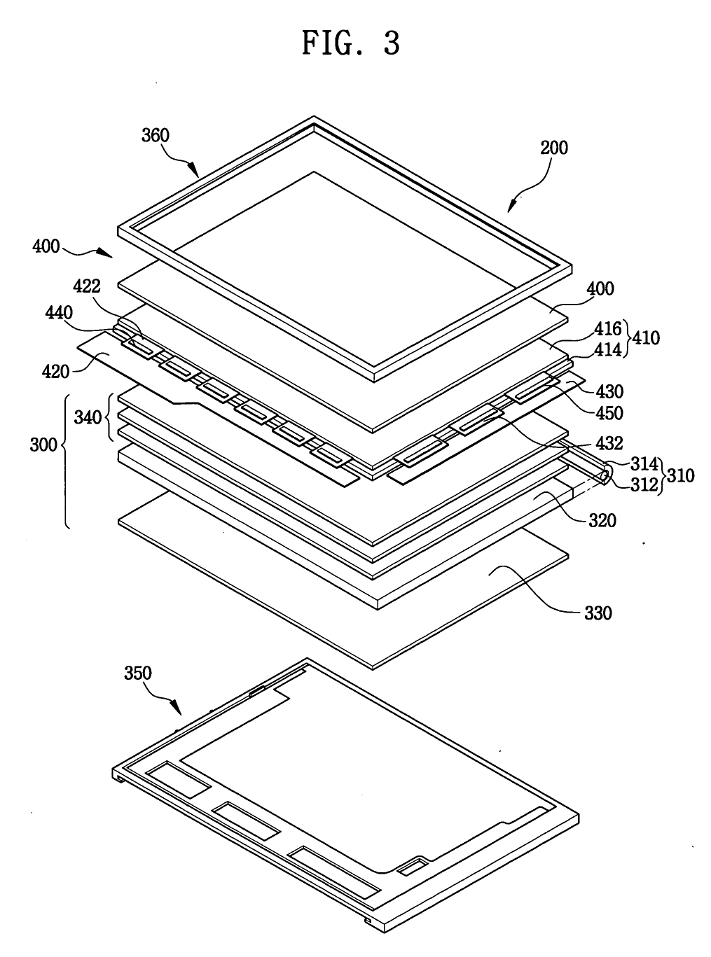

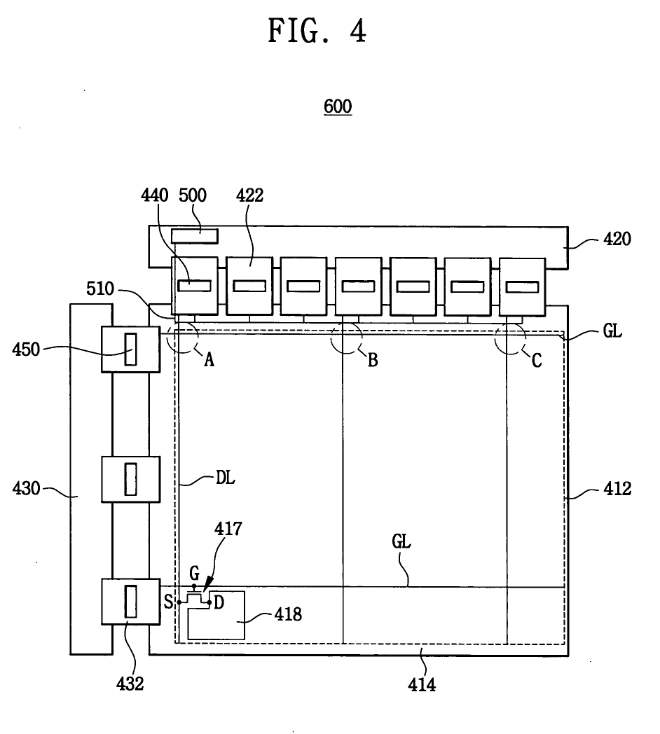

FIG. 3 is an exploded perspective view showing an LCD apparatus according to an exemplary embodiment of the present invention. FIG. 4 is a schematic plane view showing a TFT substrate and a PCB substrate shown in FIG. 3.

Referring to FIGS. 3 and 4, an LCD apparatus 200 according to an exemplary embodiment of the present invention includes a backlight assembly 300 for generating light and a display unit 400 for receiving the light generated from the backlight assembly 300 and displaying an image.

The backlight assembly 200 includes a light source part 310 and a light guide plate 320 for guiding the light from the light source part 310 and providing the guided light to the display unit 400. In this exemplary embodiment, the light source part 310 includes a lamp 312 and a lamp reflector 314 for partially covering the lamp 312 and reflecting the light emitted from the lamp 312 to the light guide plate 320.

The backlight assembly 200 further includes a reflecting plate 330 disposed under the light guide plate 320 so as to reflect the light leaked from the light guide plate 320 and provide the leaked light to the display unit 400, and a plurality of optical sheets disposed on the light guide plate 320 so as to allow the light emitted from the light guide plate 320 to have a uniform brightness.

The backlight assembly 300 and display unit 400 are successively received into a mold frame 350 disposed under the backlight assembly 300.

The LCD apparatus 200 further includes a chassis 360 opposite to the mold frame 350 so as to fix the backlight assembly 300 and the display unit 400 to the mold frame 350.

The display unit 400 includes an LCD panel 410 for displaying the image, a data PCB 420 for generating a data signal, a gate PCB 430 for generating a gate driving signal, a data driving chip 440 for receiving the data signal from the data PCB 420 and providing the data signal to the LCD panel 410 of the LCD apparatus 200, and a gate driving chip 450 for providing the gate driving signal inputted from the gate PCB 430 to the LCD panel 410.

The LCD panel 410 includes a TFT substrate 414 on which a cell array 412 is formed, a color filter substrate 416 on which a color filter (not shown) and a common electrode (not shown) and a liquid crystal layer (not shown) disposed between the TFT substrate 414 and color filter substrate 416.

The TFT substrate 414 includes a plurality of data lines DL extended in a row direction and formed at the cell array 412 and a plurality of gate lines GL extended in a column direction and formed at the cell array 412. A TFT 417 that acts as a switching device and a pixel electrode 418 are formed at a pixel area defined by the data lines DL and gate lines GL. The TFT 417 includes a gate electrode G connected to a corresponding gate line GL, a source electrode S connected to a corresponding data line DL and a drain electrode D connected to a corresponding pixel electrode 418.

In this exemplary embodiment, in a case where the LCD apparatus 200 has a resolution of 525×192, the TFT substrate 414 includes the data lines DL of 525 units and the gate lines GL of 192 units.

The gate lines GL comprise metal wires so as to provide the gate driving signal from the gate driving signal to the TFT 417 of the cell array 412. Thus, the gate lines GL act as a capacitor with the common electrode formed on the color filter substrate 416 opposite to the TFT substrate 414, so that the gate lines GL have a capacitive load. The gate lines GL also have a resistive load because of the gate lines GL acting as one of resistors.

As described above, a time needed to apply the gate driving signal to the TFT 417 may be varied according to a position of the TFT 417. That is, the capacitive load and resistive load are decided by the length of the gate lines GL that electrically connects between the gate driving chip 450 and TFT 417. Thus, when the gate driving signal is provided to a specific TFT more apart from the gate driving chip 450 than the TFT 417, the gate driving signal is delayed compared with the gate driving signal provided to the TFT 417 because the capacitive load and resistive load of the gate lines GL gradually increase.

As shown in FIG. 4, the display unit 400 may include a plurality of data driving chips and a plurality of gate driving chips.

The data driving chips are formed on a data TCP 422 electrically connecting between the LCD panel 410 and data PCB 420, and the gate driving chips are formed on a gate TCP 432 electrically connecting between the LCD panel 410 and gate PCB 430.

Also, a timing controller 500 is formed on the data PCB 420 so as to generate an output instruction signal TP as a timing signal. The output instruction signal TP generated from the timing controller 500 is provided to the data driving chip 440 via an output instruction signal line 510.

The output instruction signal line 510 is formed on an upper end of the TFT substrate 414 adjacent to the data driving chip 440 and is substantially parallel to the gate lines GL. A portion of the output instruction signal line 510 formed on the TFT substrate 414 is partially disposed on the data driving chip 440. Thus, the output instruction signal line 510 receives the output instruction signal TP generated from the timing controller 500 via the portion disposed on the data driving chip 440.

The timing controller 500 outputs a timing signal for controlling an output of the gate driving signal to the gate driving chip 450 while outputting the output instruction signal TP.

In this exemplary embodiment, the data driving chip 440 receives the data signal inputted from the data PCB 420 in a dot scanning manner via the data TCP 422 and stores the inputted data signal thereinto in a line scanning manner.

That is, the data driving chip 440 stores the data signal inputted from the data PCB 420 by a bit until the data signal corresponding to one horizontal line of a display screen is stored in the data driving chip 440. Then, the data driving chip 440 converts the stored data signal into an analog data signal in response to the output instruction signal TP and outputs the converted analog data signal to the data lines DL of the cell array 412.

The data driving chip 440 converts the stored data signal into an analog data signal in response to the output instruction signal TP provided via the output instruction signal line 510 and outputs the converted analog data signal to the data lines DL.

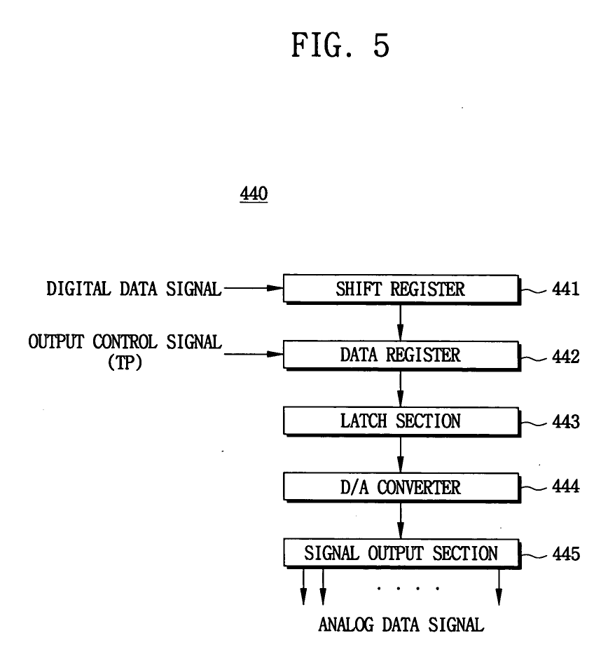

Hereinafter, an operation of the data driving chip 440 will be described in detail with reference to FIG. 5.

FIG. 5 is a block diagram showing the data driving chip shown in FIG. 3.

Referring to FIG. 5, the data driving chip 440 includes a shift register 441, a data register 442, a latch section 443, a D-A (digital-analog ) converter 444 and a signal output section 445.

The shift register 441 receives the data signal inputted from the data PCB 420 by one bit and shifts the inputted data signal so as to sequentially store the inputted data signal in the data register 442.

In case that the LCD apparatus 200 includes first to eighth data driving chips and the data signal is inputted from the data PCB 420 to the first data driving chip by one bit, the first data driving chip shifts the inputted data signal to a second data driving chip and the second driving chip shifts the inputted data signal from the first driving chip to a third driving chip.

In accordance with the shifting operations of the first to seventh data driving chips, the data signal is sequentially provided from the eighth data driving chip to the first data driving signal. When the shifting operation is completed, the data signal of about 525 bits corresponding to one horizontal line is stored in each of eighth to first data driving chips.

When the data signal of about 525 bits corresponding to one horizontal line is stored in the data register 442, the timing controller 500 outputs the output instruction signal TP to the data register 442. The output instruction signal TP is provided to the data register 442 via the output instruction signal line 510 formed on the TFT substrate 414.

Responsive to the output instruction signal TP inputted via the output instruction signal line 510, the data register 442 outputs the stored data signal to the latch section 443 at a time. The latch section 443 boosts a voltage level of the data signal inputted from the data register 442. The D-A converter 444 converts the boosted data signal from the latch section 443 into an analog data signal. The signal output section 445 amplifies the analog data signal from the D-A converter 444 and outputs the amplified analog data signal to the data lines DL.

As described above, since the output instruction signal line 510 used as a path of the output instruction signal TP is formed on the TFT substrate 414, which is substantially parallel to the gate lines GL, the output instruction signal line 510 has the capacitive load and resistive load substantially same as those of the gate lines GL.

That is, the output instruction signal line 510 has the capacitive load because the output instruction signal line 510 acts as a capacitor with the common electrode (not shown) formed on the color filter substrate 416. Also, the output instruction signal line 510 also has the resistive load because the output instruction signal line 510 acting as one of resistors.

Thus, the output instruction signal TP provided to the data driving chip 440 via the output instruction signal line 510 may be delayed due to the capacitive and resistive loads of the output instruction signal line 510.

Particularly, when the output instruction signal TP is provided to the driving chip 440 via a relatively-long output instruction signal line TP, the output instruction signal TP may be more delayed than when the output instruction signal TP is provided to the driving chip 440 via a relatively-short output instruction signal line TP. In this case, a delayed-time of the output instruction signal TP is substantially equal to a delayed-time of the gate driving signal.

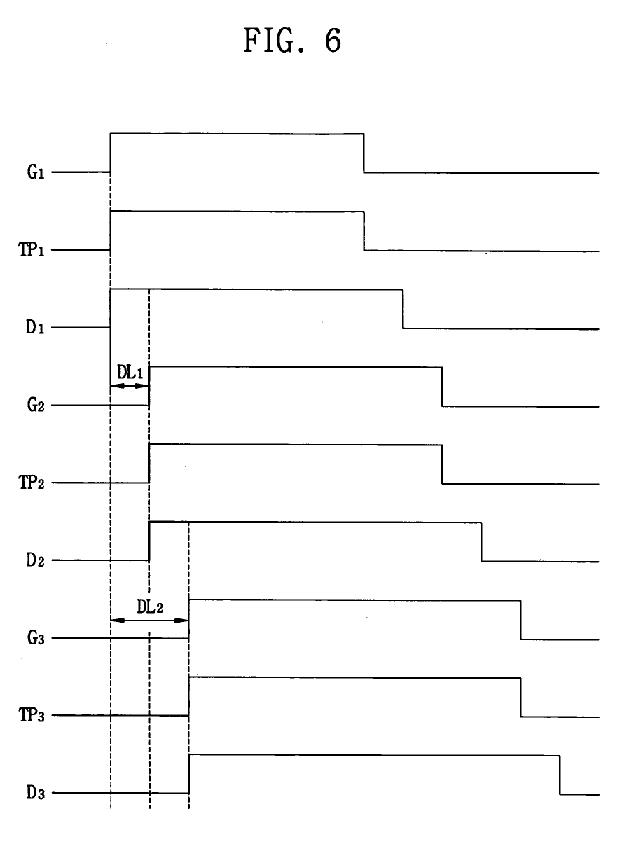

FIG. 6 is waveforms of the data and gate signals applied to areas “A” to “C” shown in FIG. 4.

As shown in FIG. 6, when the gate driving signal from the gate driving chip 450 is provided to the gate lines GL, the gate driving signal applied to a second area “B” and a third area “C” is delayed in comparison with the gate driving signal applied to a first area “A” in terms of a predetermined time.

That is, a gate driving signal G2 applied to the second area “B” of the gate lines GL is delayed by a first time DL1 compared with a gate driving signal G1 applied to the first area “A” of the gate lines GL because of the capacitive and resistive loads of the gate lines GL.

Also, a gate driving signal G3 applied to the third area “C” of the gate lines GL is delayed by a second time DL2 compared with the gate driving signal G1 applied to the first area “A” of the gate lines GL. The reason that the gate driving signal G3 applied to the third area “C” is more delayed than the gate driving signal G2 applied to the second area “B” is because the third area “C” is more apart from the gate driving chip 450 than the second area “B”. That is, the capacitive and resistive loads are gradually increased according to the length of the gate lines GL.

In comparison with a data signal D1 applied to the data lines DL corresponding to the first area “A”, a data signal D2 applied to the data lines DL corresponding to the second area “B” is delayed by the first time DL1.

Also, a data signal D3 applied to the data lines DL corresponding to the third area “C” is delayed by the second time DL2 compared with the data signal D1 applied to the data lines DL corresponding to the first area “A”.

That is, due to the capacitive and resistive loads of the output instruction signal line 510, a second output instruction signal TP2 for outputting the data signal D2 to the data lines DL corresponding to the second area “B” is more delayed by the first time DL1 than a first output instruction signal TP1 for outputting the data signal D1 to the data lines DL corresponding to the first area “A”.

Thus, the data signal D2 applied to the data lines DL corresponding to the second area “B” is also delayed by the first time DL1 in comparison with the data signal D1 applied to the data lines DL corresponding to the first area “A”.

Also, due to the capacitive and resistive loads of the output instruction signal line 510, a third output instruction signal TP3 for outputting the data signal D3 to the data lines DL corresponding to the third area “C” is more delayed by the second time D1 than the first output instruction signal TP1 for outputting the data signal D1 to the data lines DL corresponding to the first area “A”.

Thus, the data signal D3 applied to the data lines DL corresponding to the third area “C” is also delayed by the second time DL2 in comparison with the data signal D1 applied to the data lines DL corresponding to the first area “A”.

Here, the reason that the data signal D3 applied to the third area “C” is more delayed than the data signal D2 applied to the second area “B” is because the length of the output instruction signal line 510 connected between third area “C” and the timing controller 500 is longer than the length of the output instruction signal line 510 connected between the second area “B” and the timing controller 500.

The gate lines GL and output instruction signal line 510 are formed on the TFT substrate 414, so that the gate lines GL and output instruction signal line 510 have the capacitive and resistive loads substantially equal to each other.

Therefore, the gate driving signal G2 and data signal D2 applied to the second area “B” have a delayed-time of the first time DL1 substantially same as that of the gate driving signal G1 and data signal D1. Also, the gate driving signal G3 and data signal D3 applied to the third area “C” have a delayed-time of the second time DL2 substantially same as that of the gate driving signal G1 and data signal D1.

Thus, the gate driving signal applied to the gate lines is delayed in a predetermined time according to positions of pixel areas and the data signal applied to the data lines is delayed in the predetermined time, so that the gate driving signal and data signal may be applied to the pixel areas at the same time.

As aforementioned above, the LCD apparatus according to the exemplary embodiment of the present invention separately includes the output instruction signal line formed on the TFT substrate on which the gate lines are formed so as to control the output of the data signal. The gate lines and output instruction signal line have the capacitive and resistive loads substantially equal to each other because the gate lines and output instruction signal line are formed on a same substrate. Thus, the output instruction signal has the delayed-time substantially equal to the delayed-time of the gate driving signal applied to the gate line.

Accordingly, the LCD apparatus may prevent deterioration of the image, which is caused by applying-time difference between the gate driving signal and data signal, thereby improving the display quality thereof.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An LCD apparatus comprising:
an LCD panel to receive an image data externally provided and display an image;
a data driver to output the image data to the LCD panel;
a gate driver to output a gate driving signal to the LCD panel; and
a timing controller to provide a first control signal to the gate driver so as to control an output of the gate driving signal and to provide a second control signal to the data driver via a signal line formed on the LCD panel so as to control an output of the image data.

2. The LCD apparatus of claim 1, wherein the signal line is formed on an area adjacent to the data driver.

3. The LCD apparatus of claim 2, further comprising a plurality of signal transmission members electrically connecting the data driver with the LCD panel,
wherein the signal line receives the second control signal from the timing controller via one of the signal transmission members.

4. The LCD apparatus of claim 3, wherein the LCD panel comprises:
a plurality of gate lines to receive the gate driving signal via the gate driver, the gate lines disposed on the LCD panel, extended in a first direction and arranged in a second direction substantially perpendicular to the first direction; and
a plurality of data lines to receive the image data via the data driver, the data lines disposed on the LCD panel, extended in the second direction and arranged in the first direction.

5. The LCD apparatus of claim 4, wherein the signal line is extended in the first direction and is substantially parallel to the gate lines.

6. The LCD apparatus of claim 4, wherein the LCD panel comprises a plurality of pixel areas defined by the gate and data lines, and the gate driving signal is provided to a corresponding pixel area at a same time as that of the image data provided to the corresponding pixel area.

7. An LCD apparatus comprising:
an LCD panel to receive an image data and display an image;
a data driver to output the image data to the LCD panel;
a gate driver to output a gate driving signal to the LCD panel;
a timing controller to provide a first control signal to the gate driver so as to control an output timing of the gate driving signal and provide a second control signal to the data driver so as to control an output timing of the image data;
a plurality of signal transmission members to electrically connect the data driver with the LCD panel; and
a signal line to provide the second control signal to the data driver via one of the signal transmission members.

8. The LCD apparatus of claim 7, wherein the LCD panel comprises:
a plurality of gate lines extended in a first direction and arranged in a second direction substantially perpendicular to the first direction; and
a plurality of data lines extended in the second direction and arranged in the first direction.

9. The LCD apparatus of claim 8, wherein the signal line is extended in the first direction and is substantially parallel to the gate lines.

10. The LCD apparatus of claim 9, wherein the LCD panel comprises a plurality of pixel areas defined by the gate and data lines, and the gate driving signal and the image data are substantially simultaneously provided to a corresponding pixel area.

11. The LCD apparatus of claim 7, wherein the signal line is formed on the LCD panel and adjacent to the data driver.

12. An LCD apparatus comprising:
an LCD panel;
a data driver coupled to the LCD panel;
a gate driver coupled to the LCD panel;
a timing controller coupled to the gate driver and to the data driver; and
a signal line formed on the LCD panel, the signal line electrically connecting the timing controller with the data and gate drivers.

13. The LCD apparatus of claim 12, wherein the signal line is formed on an area adjacent to the data driver.

14. The LCD apparatus of claim 13, further comprising a plurality of signal transmission members electrically connecting the data driver with the LCD panel,
wherein the signal line receives a control signal from the timing controller via one of the signal transmission members so as to control an output of a image data from the data driver.
